(19) United States
(12) Patent Application Publication
(10) Pub. No.: US 2014/0312627 A1
(43) Pub. Date: Oct. 23, 2014

(54) MOTOR VEHICLE COVER LOCKING ARRANGMENT

(71) Applicant: GM GLOBAL TECHNOLOGY OPERATIONS LLC, Detroit, MI (US)

(72) Inventors: Markus Frommann, Bingen am Rhein (DE); Heiko Betzen, Bausendorf (DE)

(73) Assignee: GM GLOBAL TECHNOLOGY OPERATIONS LLC, Detroit, MI (US)

(21) Appl. No.: 14/221,039

(22) Filed: Mar. 20, 2014

(30) Foreign Application Priority Data
Mar. 20, 2013 (DE) 102013004792.7

(51) Int. Cl. E05C 19/02

(52) U.S. Cl. CPC E05C 19/022
USPC 292/57

(57) ABSTRACT

A locking arrangement for a pivotable flap or cover on a motor vehicle is disclosed. The cover locking arrangement includes a slotted link element with a control groove, a holding element with a sliding element and a torsion element. The control groove has a first loading section, through which upon an axial displacement of the sliding element guided in the control groove in a closing direction, slotted link element and holding element are rotated against one another subject to loading the torsion element.

### CROSS REFERENCE TO RELATED APPLICATION

This application claims priority to German Patent Application No. 102013004792.7 filed Mar. 20, 2013, which is hereby incorporated by reference in its entirety.

### TECHNICAL FIELD

The present disclosure relates to an arrangement for locking a pivotable flap or cover, in particular tank cover, of a motor vehicle, and to a motor vehicle, in particular a passenger car having such a cover locking arrangement.

### BACKGROUND

From DE 10 2009 060 119 A1 an actuating device for opening and closing a cover in or on a motorcar with a push-push kinematic is known. The device has a helical groove for the positive guidance of a plunger and a rotatably mounted ring. Through successive strokes (“push-push”) the plunger alternately rotates the ring into positions, in which the ring axially fixes or releases this plunger.

### SUMMARY

It is an object of an embodiment of the present disclosure to make available a motor vehicle with an improved push-push kinematic.

A cover locking arrangement for a pivotable flap or cover, in particular a tank cover of a motor vehicle such as a passenger car, according to an aspect of the present disclosure includes a slotted link element and a holding element having at least one sliding element. The sliding element can be formed integrally with the holding element, and/or as a radial projection, in particular with a circular, elliptical, drop-shaped cross-section or the like in order to improve the production and/or function.

The slotted link element has a control groove for guiding the sliding element, which in the following is described as first control groove without restriction of the generality. In an embodiment the holding element, in particular for improving the stability and/or reliability, includes one or multiple sliding elements, which are equidistantly distributed over the circumference of the holding element. As presently preferred, two sliding elements are located radially opposite. The slotted link element in a further development includes one or multiple control grooves for guiding the further sliding elements, which are preferably formed parallel to the one (first) control groove. Equally, the slotted link element can also include exactly one single control groove, in particular for improving tolerance sensitivity.

The control grooves are preferably closed control groove(s). Here, this is to mean in particular that the sliding element is continuously guided in the latter. Equally, the control groove(s) can be formed as an open control groove(s). Here, this is to mean in particular that the sliding element, in particular during a closing of the cover, can be guided into the control groove, and during an opening of the cover can be guided out of the control groove.

In the case of a sliding element guided in a control groove or when a sliding element is guided in a control groove, the holding element is axially displaceable and rotatably guided in the slotted link element, in particular in order to improve stability and/or reliability. In particular, the slotted link element can have a circle-cylindrical recess and the holding element a circle-cylindrical circumferential surface, which in a further development forms a clearance fit with the recess. Equally, in an embodiment, the slotted link element can be axially displaceably and rotatably guided in the holding element. In particular, the holding element can be formed annularly for this purpose and have a circle-cylindrical recess and the slotted link element a circle-cylindrical circumferential surface, which in a further development forms a clearance fit with the recess.

In an embodiment, the slotted link element is arranged fixed to the body and the holding element guided thereon can be connected to the cover in particular in a positively joined manner, for example in the manner explained in DE 10 2009 060 119 A1. Equally, the holding element can be permanently connected to the cover, in particular when the control groove(s) is or are formed open. In another embodiment, the holding element is conversely arranged fixed to the body and the slotted link element guided thereon can be releasably connected, in particular in a positively joined manner, to the cover, for example in the manner explained in DE 10 2009 060 119 A1. Equally, the slotted link element can be permanently connected to the cover, in particular when the control groove(s) is (are) formed open.

As is evident in particular from an embodiment with a slotted link or holding element, which is connected to a pivotable cover in a fixed manner, an axial movement of slotted link and holding element in a closing direction can be realized in particular also through a pivoting of the one of the slotted link and the holding element against the other one of the slotted link and the holding element. For the more compact realization, such a not purely linear movement is also described as an axial movement of slotted link and holding element relative to one another in or against a closing direction.

The cover locking arrangement in an embodiment include a torsion means, in order to elastically tie slotted link and holding element, at least in the case of a sliding element guided in the control groove, in a rotational direction so that a rotation of slotted link and holding element against one another from a relaxed position loads the torsion means so that it attempts to reset slotted link and holding element into the relaxed position. A torsion means can in particular support itself on the holding element and the cover. Additionally or alternatively, the torsion means fixed on the body can support itself on the slotted link element.

In an embodiment, a torsion means can be formed in particular for a reduction of installation space and/or for increasing the reliability, integrally with the holding element. In particular, the torsion means can be a leaf or coil spring, or a profile rod. In an embodiment, a torsion means can in particular additionally compensate for a purely linear axial movement, in particular as a result of a pivoting of slotted link and holding element relative to one another. The control groove(s) comprise(s) a loading section each, which in the following is described as first loading section without restriction of the generality. This first loading section in an embodiment is formed in such a manner that upon an axial displacement in a closing direction the sliding element which is guided in the first loading section of the control groove is forced aside in circumferential direction and thus through the loading section the slotted link element and the holding element are rotated against one another subject to loading the torsion means, in particular in the same direction as the first loading section. At least at the end of the second loading section, slotted link and holding element in an embodiment are thus loaded against one another through the torsion means. A second loading section can in particular have an S-shaped section, in particular be formed S-shaped. In an embodiment, first and second loading sections are formed equal to a control groove, in particular in order to realize same strokes. In a modification, these can also be formed differently, in particular in order to realize different locking and unlocking strokes.

In an embodiment, the second loading section is followed by a return shoulder in closing direction. This is formed in an embodiment in such a manner that following traversing or moving over the second loading section in closing direction the sliding element which is guided in the return shoulder of the control groove can rotate back in the latter in circumferential direction, as a result of which the torsion means partly or completely relaxes. In an embodiment, the return shoulder thus makes possible a rotating back of slotted link and holding element against one another which is in the opposite direction to the forcing aside by the second loading section subject to the at least partial relaxing of the torsion means. A return shoulder can in particular at least substantially run in circumferential direction.

In an embodiment, the return shoulder is followed by a return section against the closing direction or in the opposite direction to the second loading section and spaced from the latter in circumferential direction. In an embodiment, this is formed in such a manner that upon an axial displacement against the closing direction the sliding element which is guided in the return section of the control groove is guided past the first and second loading section and the engagement shoulder. To this end, it can be forced aside in circumferential direction in a further development and the slotted link and the holding element thus be rotated against one another through the return section subject to the loading of the torsion means, in particular in the opposite direction to the first loading section. In an embodiment, the reliability of the push-push kinematic can be improved through this and/or an installation space be better utilized. A return section can in particular have an S-shaped section, in particular be formed S-like.

Through the return shoulder, the second loading section connected upstream and the return section connected downstream the unlocking stroke of a push-push kinematic is realized in an embodiment: following the passing-through of the second loading section, the at least partially relaxed torsion means moves the sliding element into the return section, which makes possible a pulling-out against the closing direction.

As explained above, the control groove(s) can be formed open, in particular in order to detach slotted link and holding element from one another in axial direction. In an embodiment, a first loading section comprises a face-end guiding-in opening for guiding the sliding element into the control groove and the associated return section a face-end guiding-out opening for discharging the sliding element into the control groove. The guiding-in opening in an embodiment can be formed divergent to the face end, in order to facilitate introduction. In an embodiment, an in closing direction first end of the first loading section, in particular an guiding-in opening, is located in circumferential direction at least substantially opposite the associated sliding element when the torsion means is relaxed.

In an embodiment, the control groove(s) is or are formed closed and each includes a further shoulder connecting the return and the loading section. This is formed in such a manner that following the traversing or moving over the return section against the closing direction the sliding element which is guided in the further shoulder of the closed control groove can rotate back in the latter in circumferential direction, as a result of which the torsion means is partially or completely relaxed. The further shoulder can in particular make possible also a turning back of slotted link and holding element against one another in a direction that is opposite to a forcing aside by the return section subject to at least partial relaxing of the torsion means. The further shoulder can in particular at least substantially run in circumferential direction.

In an embodiment, the cover locking arrangement includes a movable stop for the optional blocking of a movement of slotted link and holding element against one another in closing direction. By positively blocking moving of slotted link and holding element against one another in closing direction into the return shoulder, in particular out of the engagement shoulder through the disengaged stop, an unlocking stroke for transferring a sliding element into the return section and thus an undesirable unlocking of the cover can be prevented.

In an embodiment, the stop can be electrically (in particular electromotorically or electromagnetically), hydraulically and/or pneumatically adjusted or optionally engaged and disengaged. In a further development, the stop is axially displaceably guided in the slotted link element when on the holding element is also axially displaceably guided. Alternately, it can be axially displaceably guided on the holding element when on the latter the slotted link element is also axially displaceably guided. The stop, in an embodiment, can be guided on the slotted link element aligned with the holding element or guided on the holding element aligned with the slotted link element. Additionally or alternatively, the stop can be guided in a rotationally fixed manner on, in particular in, the slotted link or holding element.

### BRIEF DESCRIPTION OF THE DRAWINGS

The present disclosure hereinafter will be described in conjunction with the following drawing figures, wherein like numerals denote like elements, and:

FIG. 1 is a cover locking arrangement according to an embodiment of the present invention in a perspective view with slotted link and holding element radially spaced for illustration with a sliding body at the start of a first loading section;

FIG. 2 shows the cover locking arrangement in a representation corresponding to FIG. 1 with the sliding body at the end of the first loading section;

FIG. 3 shows the cover locking arrangement in a representation corresponding to FIG. 2 with the sliding body in an engagement shoulder;

FIG. 4 shows the cover locking arrangement in a representation corresponding to FIG. 3 with the sliding body at the end of a second loading section;

FIG. 5 shows the cover locking arrangement in a representation corresponding to FIG. 4 with the sliding body in a return shoulder;

FIG. 6 shows the cover locking arrangement in a representation corresponding to FIG. 5 with the sliding body in a return section;

FIG. 7 shows the cover locking arrangement in a representation corresponding to FIG. 1 with a movable stop; and

FIG. 8 shows cover locking arrangements according to further embodiments in a representation corresponding to FIG. 1 with different torsion means.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

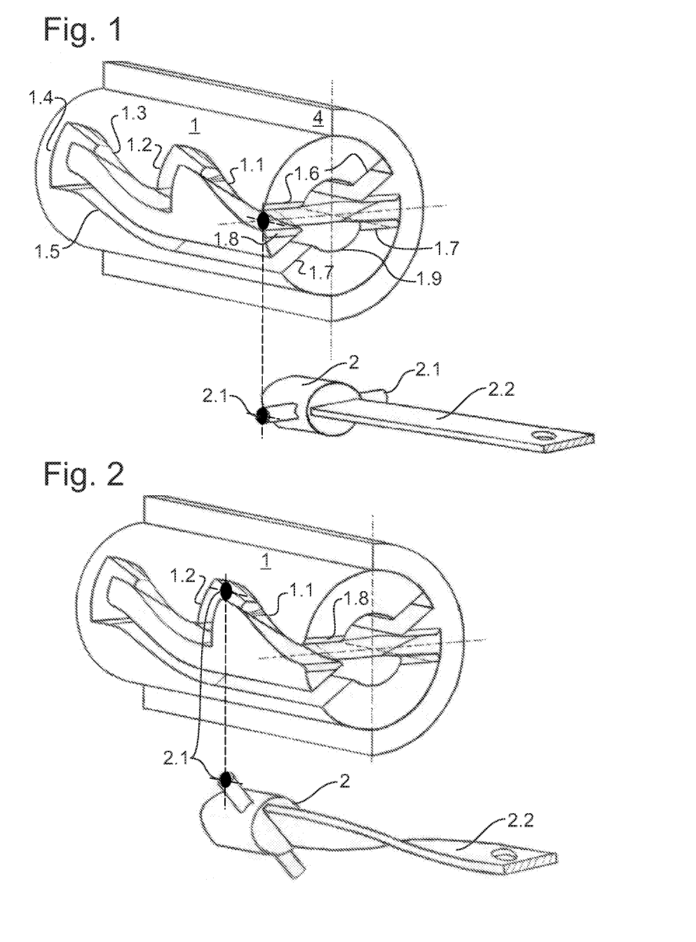

FIG. 1 shows a flap or cover locking arrangement for a pivotable tank cover of a passenger car according to an embodiment of the present invention in a perspective view.

The cover locking arrangement includes a slotted link element 1 and a holding element 2, which is shown radially spaced for illustration. The holding element 2 has two sliding elements 2.1 located radially opposite in the form of radial projections with circular cross-section. The slotted link element 1 includes two control grooves for guiding these sliding elements 2.1, which are formed parallel to one another, so that only the front (first) control groove shown in FIG. 1 is discussed and the other (further) control groove is made reference to here.

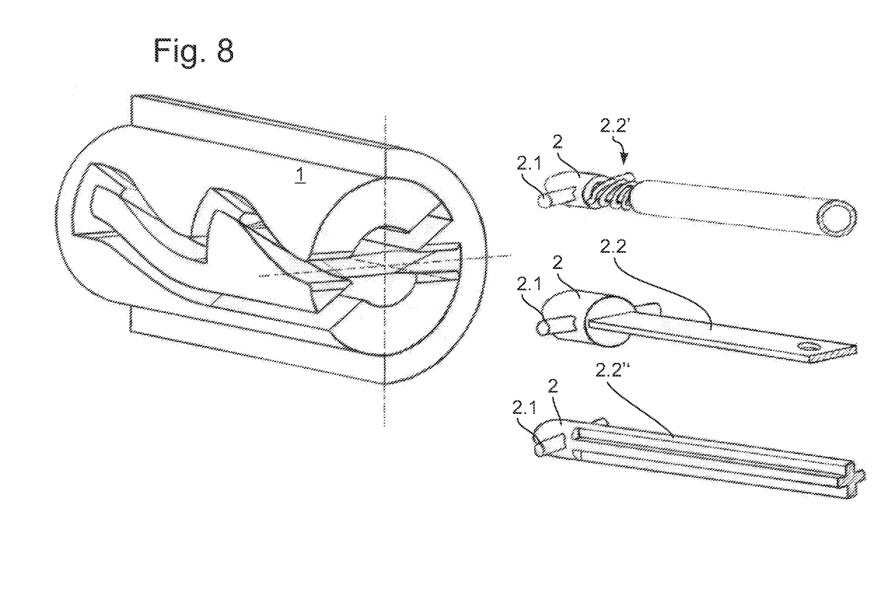

In the exemplary embodiment, the slotted link element 1 is connected to a body 4, in particular a body connecting element such as a tank recess, and the holding element 2 permanently connected or releasably connected to the tank cover (not shown). Integrally formed with the holding element 2 is a torsion means in the form of a leaf spring 2.2. In further embodiments shown in FIG. 8, the torsion means can be formed as a coil spring 2.2′ (top in FIG. 8) or profile rod 2.2″ (bottom in FIG. 8).

When the sliding elements 2.1 are guided into the control grooves, the torsion means 2.2 or 2.2′ or 2.2″ ties slotted link element 1 and holding element 2 elastically to one another in a rotational direction so that a rotation of slotted link and holding element 1, 2 against one another from a relaxed position shown in FIG. 1 loads the torsion means 2.2 or 2.2′ or 2.2″.

Through pivoting the flap or cover closed, the holding element 2 is axially displaced in a closing direction (from the right to the left in FIG. 1). In particular when the holding element 2 is connected in a fixed or rigid manner to the tank cover, it does not perform a purely linear but a curved axial movement in the process, wherein deviations from a purely linear movement are compensated for by the elastic holding element 2 or its torsion means 2.2 or 2.2′ or 2.2″.

As a consequence of the closing movement, the tip of the holding element 2 facing the slotted link element 1 initially dips into a circle-cylindrical through-bore 1.9 of the slotted link element, which forms a clearance fit with the holding element 2, in order to axially displaceably and rotatably guide the holding element 2 in the slotted link element 1. Upon further axial movement, the sliding elements 2.1 subsequently dip into the base-end guiding-in openings 1.6 of the two control grooves. As explained above, slotted link element and holding element 1, 2 are represented radially drawn apart or spaced from one another for illustration, wherein the position of the in FIG. 1 front sliding element 2.1 in the control groove is indicated through its radial face end shown dark.

The control grooves each have a first S-shaped loading section 1.1, in order to force the sliding element 2.1 which is guided in the first loading section aside in circumferential direction during an axial displacement in closing direction, thus rotating the slotted link element and the holding element 1, 2 while twisting or loading the torsion means 2.2 or 2.2′ or 2.2″ against one another so that at the end of the first loading section 1.1 (see FIG. 2) slotted link element and holding element 1, 2 are loaded against one another through the twisted or loaded torsion means 2.2 or 2.2′ or 2.2″.

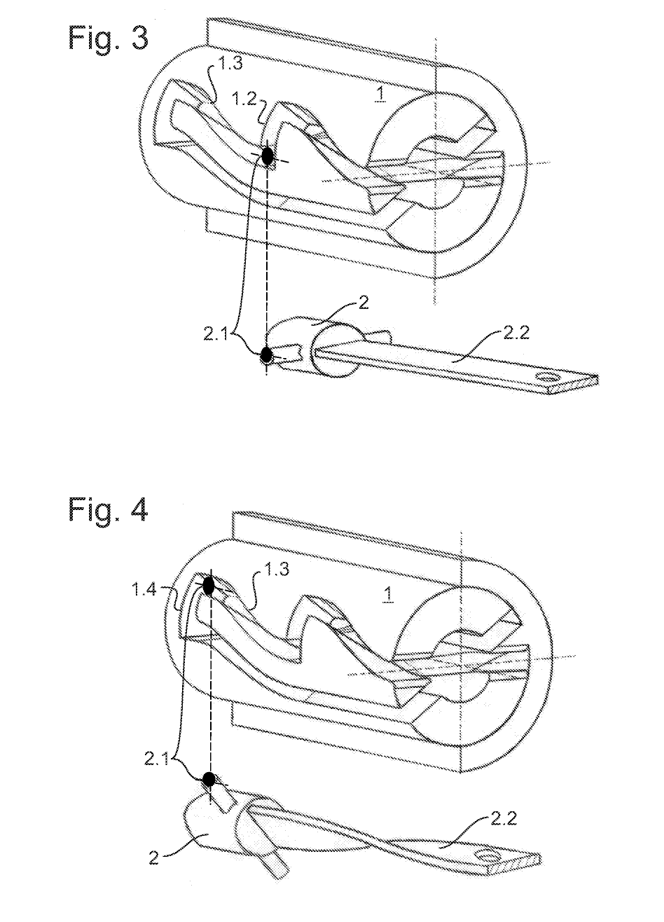

The first loading section 1.1 is followed in closing direction by an engagement shoulder 1.2 each running in circumferential direction, in which following the moving over of the first loading section 1.1 in closing direction (FIG. 2→FIG. 3) the sliding element 2.1 guided in the engagement shoulder 1.2 can rotate back in circumferential direction, as a result of which the torsion means 2.2 or 2.2′ or 2.2″ relaxes (see FIG. 3). The engagement shoulder 1.2 thus makes possible a rotating back of slotted link element and holding element 1.2 that is in the opposite direction to the forcing aside by the first loading section 1.1 against one another subject to the relaxing of the torsion means 2.2 or 2.2′ or 2.2″.

The locking stroke of a push-push kinematic is represented by the engagement shoulder 1.2 and the first loading section 1.2 connected upstream: following the traversing of the first loading section (FIG. 1→FIG. 2→FIG. 3) the relaxed torsion means 2.2 or 2.2′ or 2.2″ positively engages the sliding elements 2.1 in the respective engagement shoulder 1.2. The engagement shoulder 1.2 thus counteracts a pulling-out against the closing direction, and the torsion means 2.2 or 2.2′ or 2.2″ it's overcoming.

The engagement shoulder is followed in closing direction by a second S-shaped loading section 1.3, which is formed equal to the first loading section 1.1, in order to force the sliding element 2.1 which is guided in the second loading section 1.3 during a further axial displacement in the closing direction in circumferential direction, thus rotating slotted link element and holding element 1, 2 against one another subject to loading the torsion means 2.2 or 2.2′ or 2.2″ in the same direction as the first loading section 1.1, so that at the end of the second loading section 1.3 (see FIG. 4) slotted link element and holding element 1, 2 are again loaded against one another through the torsion means 2.2 or 2.2′ or 2.2″.

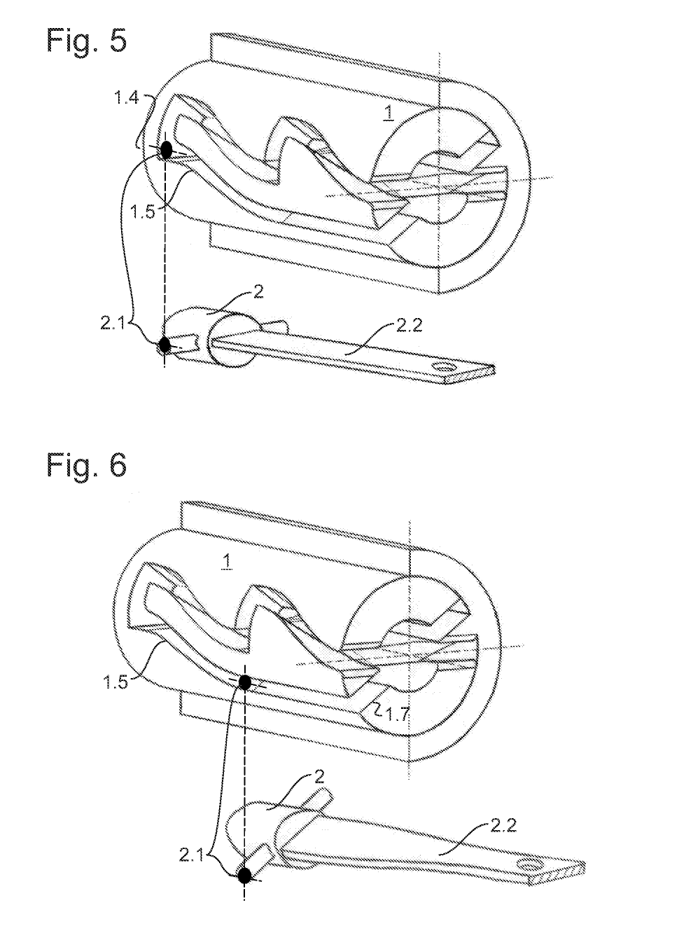

The second loading section 1.3 is followed in closing direction by a return shoulder 1.4 each running in circumferential direction, in which following the moving over of the second loading section 1.3 in closing direction (as shown in progression of FIGS. 3-5) the sliding element 2.1 which is guided in the return shoulder 1.4 can rotate back in circumferential direction, as a result of which the torsion means 2.2 or 2.2′ or 2.2″ relaxes (see FIG. 5). The return shoulder 1.4 thus makes possible a turning back of slotted link and holding element 1, 2 against one another in the opposite direction to the forcing aside by the second loading section 1.3 subject to relaxing the torsion means 2.2 or 2.2′ or 2.2″.

The return shoulder 1.4 is followed against the closing direction or in the direction opposite to the second loading section 1.3 and spaced from the latter in circumferential direction by a return section 1.5, in order to guide the sliding element 2.1 past the first and the second loading section 1.1, 1.3 and the engagement shoulder 1.2 upon an axial displacement against the closing direction and to force it aside in circumferential direction, thus rotating the slotted link element and holding element 1.2 against one another subject to loading the torsion means 2.2 or 2.2′ or 2.2″. The return section 1.5 has an S-shaped section (left in FIG. 1), in order to rotate slotted link element and holding element 1, 2 in the direction opposite to the first loading section 1.1 and the second loading section 1.3.

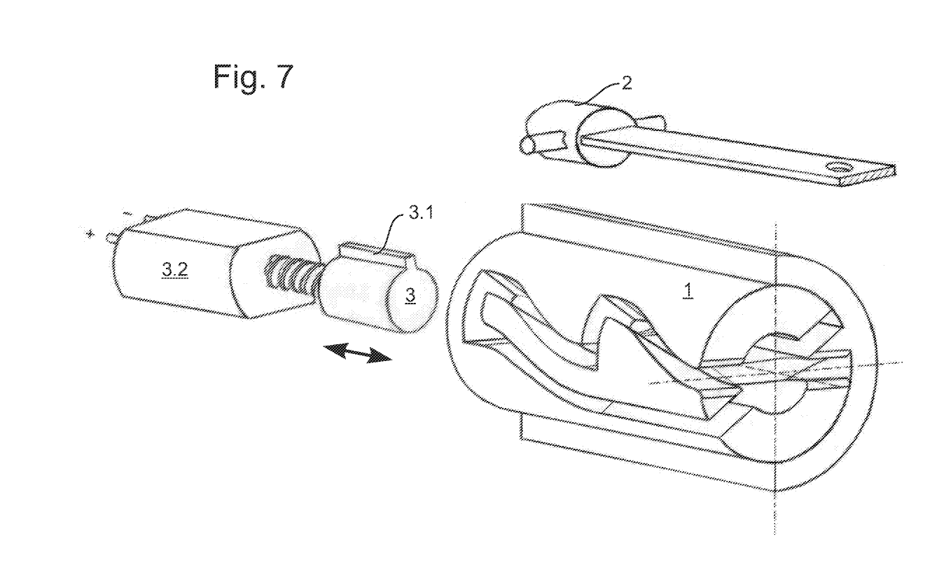

Through the return shoulder 1.4, the second loading section 1.3 connected upstream and the return section 1.5 connected downstream, the unlocking stroke of a push-push kinematic is realized. Following traversing of the second loading section 1.3, the relaxing torsion means 2.2 or 2.2′ or 2.2″ moves the sliding element 2.1 into the return section 1.5, which makes possible a pulling out against the closing direction (as shown in progression of FIG. 5 and FIG. 6).

The control grooves are formed open and have guiding-out openings 1.7 which are offset with respect to the guiding-in openings 1.6 in circumferential direction, in order to detach slotted link element and holding element 1, 2 from one another in axial direction. With slotted link element and holding element 1, 2 detached from one another, the torsion means 2.2 or 2.2′ or 2.2″ relaxes. The face-end guiding-in openings 1.6 of the first loading sections 1.1 are formed divergent to the face end (right in FIG. 1) of the slotted link element 1 facing the holding element 2 in order to facilitate introduction. In the exemplary embodiment, these have bevels 1.8.

The guiding-in openings 1.6 are located opposite the associated sliding element 2.1 in circumferential direction when the torsion means 2.2 or 2.2′ or 2.2″ is relaxed (see FIG. 1). Through renewed moving of the holding element 2 in closing direction a new push-push cycle is initiated or a locking stroke initiated (as shown in the progression from FIG. 6 to FIG. 1).

The cover locking arrangement has a movable stop 3 (see FIG. 7) for the optional blocking of a movement of slotted link elements and holding element 1, 2 against one another in closing direction. The stop 3 is guided in the slotted link element 1 by means of an axial rib 3.1 in a rotationally fixed and axially displaceable manner aligned with the holding element 2 and is optionally engaged and disengaged through an electric motor 3.2. In a position disengaged against the closing direction, it prevents a further movement of the sliding elements 2.1 in closing direction beyond the engagement shoulder 1.2, so that an unlocking stroke is positively blocked. In a position (FIG. 7) engaged in closing direction it makes possible, by contrast, the movement of the holding element shown in FIG. 4-6.

Although in the preceding description exemplary embodiments were explained it is pointed out that a multiplicity of modifications is possible. It is additionally pointed out that the exemplary embodiments are merely examples which are not intended to restrict the scope of protection, the applications and the construction in any way. The preceding description rather provides the person skilled in the art with a guideline for implementing at least one exemplary embodiment, wherein various changes, in particular with respect to the function and arrangement of described components can be made without leaving the scope of protection as is obtained from the claims and feature combinations equivalent to these.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A cover locking arrangement for a pivotable cover of a motor vehicle comprising:
a slotted link element with a control groove; and
a holding element coaxially positioned in the slotted link element, the holding element having a torsion element and a sliding element disposed on an end of the torsion element and at least partially extending into the control groove;
wherein the control groove includes a first loading section through which the slotted link element and the holding element are rotated relative to one another upon an axial displacement of the sliding element which is guided in the control groove and subject to loading the torsion element.

17. The cover locking arrangement according to the preceding claim 16, wherein the control groove comprises an engagement shoulder following the first loading section to rotate the slotted link element and holding element back against one another after traversing of the first loading section in a closing direction subject to at least partial relaxing of the torsion element.

18. The cover locking arrangement according to claim 17, wherein the control groove comprises:
a second loading section following the engagement shoulder, through which upon a further axial displacement of the sliding element which is guided in the control groove in closing direction, slotted link element and holding element are rotated relative to one another subject to loading the torsion element; and
a return shoulder following the second loading section for rotating slotted link element and holding element back against one another following traversing of the second loading section in closing direction subject to at least partial relaxing of the torsion element.

19. The cover locking arrangement according to claim 18 wherein at least one of the first loading section and the second loading section has a substantially S-shaped section.

20. The cover locking arrangement according to claim 18, wherein the control groove comprises a return section following the return shoulder for guiding the sliding element past the first and second loading section and the engagement shoulder upon an axial displacement of slotted link element and holding element relative to one another against the closing direction.

21. The cover locking arrangement according to claim 20 wherein at least one of the first loading section, the second loading section and the return section has a substantially S-shaped section.

22. The cover locking arrangement according to claim 20 wherein the return section is formed in such a manner that through the sliding element guided in the return section the slotted link element and holding element upon an axial displacement against one another are rotated against the closing direction subject to the loading of the torsion element against one another in the direction that is opposite to that of the first loading section.

23. The cover locking arrangement according to claim 16, wherein the control groove comprises an open control groove including a face-end guiding-in opening formed in the first loading section for guiding the sliding element into the control groove, and a face-end guiding-out opening formed in the return section for outputting the sliding element into the control groove.

24. The cover locking arrangement according to claim 16, wherein the control groove comprises a closed control groove including a further shoulder connecting the return section and the first loading section for rotating slotted link element and holding element relative to one another with the sliding element guided in the control groove following traversing of the return section against the closing direction subject to at least partial relaxing of the torsion element.

25. The cover locking arrangement according to claim 16 wherein the torsion element comprises an element integrally formed with at least one of the slotted link element and holding element.

26. The cover locking arrangement according to claim 16, wherein the torsion element is selected from the group consisting of a leaf spring, a coil spring, a profile rod or combinations thereof.

27. The cover locking arrangement according to claim 16, wherein the first loading section has a substantially S-shaped section.

28. The cover locking arrangement according to claim 16, wherein the engagement shoulder at least substantially runs in a circumferential direction.

29. The cover locking arrangement according to claim 20, wherein at least one of the engagement shoulder and the return shoulder at least substantially runs in circumferential direction.

30. The cover locking arrangement according to claim 16, wherein one of the slotted link element and the holding element is axially displaceably and rotatably guided in the other one of slotted link element and the holding element with the sliding element being guided in the control groove.

31. The cover locking arrangement according to claim 16 further comprising an electrically movable stop for the optional blocking of a movement of slotted link element and holding element against one another in closing direction.

32. The cover locking arrangement according to claim 31, wherein the stop is axially displaceably guided with one of the slotted link element and the holding element and in a rotationally fixed manner with the other one of the slotted link element and the holding element.

33. The cover locking arrangement according to claim 16 wherein the holding element further comprises a second sliding element disposed on an end of the torsion element opposite the sliding element, the second sliding element being at least partially extending into a second control groove.

34. The cover locking arrangement according to claim 16 in combination with a pivotable cover on a vehicle body, wherein one of the slotted link element and the holding element is arranged fixed to the vehicle body and the other of the slotted link element and the holding element being connected to the cover.
